(19) United States
(12) Patent Application Publication
(10) Pub. No.: US 2002/0006044 A1
(43) Pub. Date: Jan. 17, 2002

(54) Assembly of a display device and an illumination system

(75) Inventors: Gerard Harbers, Best (NL); Christoph Gerard August Hoelen, Eindhoven (NL)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/846,607

(22) Filed: Apr. 30, 2001

(30) Foreign Application Priority Data
May 4, 2000 (EP) 00201605.3

(51) Int. Cl. F21V 7/04

(52) U.S. Cl. 362/555; 362/561; 362/559

(57) ABSTRACT

The system comprises a display device having a pattern of pixels associated with color filters (5B, 5G, 5R) and a backlight system for illuminating the display device, which backlight system comprises a light-emitting panel (11) and a light source (16) associated with the light-emitting panel (11). The light source (16) comprises a plurality of light-emitting diodes (LEDs) of at least three different colors, the LEDs being associated with the color filters (5B, 5G, 5R). Preferably, the spectral emission of each of the LEDs substantially matches the transmission spectrum of the color filters (5B, 5G, 5R). Preferably, the bandwidth (FWHM=full width at half maximum) of the LEDs ranges from 10≦FWHM≦50 nm. Preferably, the intensity of the light emitted by the LEDs varies with the light level of the image to be displayed by the display device. Preferably, the intensity of the light emitted by the backlight system is controllable on a frame-to-frame basis and, preferably, for each color. Preferably, the LEDs comprise a plurality of red, green, blue (and amber) LEDs, each having a luminous flux of at least 5 lumen. Due to the comparatively small bandwidth of the LEDs, much larger color spaces can be obtained using existing color filter technology.

The invention relates to an assembly comprising

a display device provided with a pattern of pixels associated with color filters, and

an illumination system for illuminating the display device,

said illumination system comprising a light-emitting panel and at least one light source, said light source being associated with the light-emitting panel.

The invention further relates to a display device for use in said assembly.

The invention also relates to an illumination system for use in said assembly.

Such assemblies are known per se. They are used, inter alia, in television receivers and monitors. Such assemblies are particularly applied in non-emissive displays, such as liquid crystal display devices, also referred to as LCD panels, in combination with so-called backlights, for example edge lighting illumination systems. Such illumination systems are used, in particular, in display screens of (portable) computers or in datagraphic displays, for example (cordless) telephones, in navigation systems, in vehicles or in (process) control rooms.

In general, a display device mentioned in the opening paragraph comprises a substrate provided with a regular pattern of pixels, which are each driven by at least one electrode. In order to form an image or a datagraphic representation in a relevant area of a (display) screen of the (picture) display device, the display device employs control electronics, for example a control circuit. In an LCD device, the light originating from the backlight is modulated by means of a switch or a modulator, and use is made of various types of liquid crystal effects. Besides, the display may be based on electrophoretic or electromechanical effects.

In the illumination system mentioned in the opening paragraph, the light source used generally is a tubular low-pressure mercury vapor discharge lamp, for example one or more compact fluorescent lamps, wherein the light emitted, in operation, by the light source is coupled into the light-emitting panel, which functions as an optical waveguide. This optical waveguide generally forms a comparatively thin and flat panel which is made, for example, of a synthetic resin or glass, light being transported through said optical waveguide under the influence of (total) internal reflection.

Such an illumination system may alternatively be provided with a light source in the form of a plurality of optoelectronic elements, also referred to as electro-optical elements, for example electroluminescent elements, such as light-emitting diodes (LEDs). These light sources are generally provided in the proximity of, or in contact with, a light-transmitting (edge) area of the light-emitting panel, so that, in operation, light originating from the light source is incident on the light-transmitting (edge) area and diffuses in the panel.

EP-A 915 363 discloses an assembly of an LCD display device and an illumination system, wherein the illumination system comprises two or more light sources for generating light of different color temperatures. In this manner, the LCD display device is illuminated in accordance with the desired color temperature. For the light source use is made of different types of fluorescent lamps which, in operation, emit light of different, comparatively high color temperatures.

An assembly of the above-mentioned type has the disadvantage that the light source in the illumination system of the known assembly has a fixed electromagnetic spectrum, which is a mixture of different wavelengths in the visible range. This leads to a reduction of the efficiency of the assembly. Besides, this causes the color rendition by the display device to be limited.

It is an object of the invention to completely, or partly, overcome the above-mentioned disadvantages. The invention more particularly aims at providing an assembly of the type mentioned in the opening paragraph, wherein the efficiency of the assembly is increased and the color-rendering capacity of the display device improved.

In accordance with the invention, this object is achieved in that the light source comprises at least three light-emitting diodes having different light-emission wavelengths, said light-emitting diodes being associated with the color filters.

In the claims and in the description of this invention, “a LED associated with a color filter” is to be taken to mean that said LED is matched to the relevant color filter in such a manner that the spectral emission of the relevant LED corresponds substantially with the spectral maximum of the relevant color filter. In general, the color filter comprises three color filters, each of which passes a different color, i.e. a blue, a green and a red color filter. In the example wherein the light source comprises LEDs having three different light-emission wavelengths, the light source generally includes blue, green and red LEDs. In this case, “associated with” means that the spectral emission of the blue LED is substantially adapted to the “transmission” spectrum of the blue color filter, the spectral emission of the green LED is substantially adapted to the (transmission) spectrum of the green color filter, and the spectral emission of the red LED is substantially adapted to the (transmission) spectrum of the red color. If the light source is composed of LEDs having four different light-emission wavelengths, the light source generally comprises blue, (bluish) green, amber and red LEDs. In this case, “associated with” means that the spectral emission of the blue LED is substantially adapted to the (transmission) spectrum of the blue color filter, while the emission spectra of the (bluish) green, amber and red LEDs are selected such that the three of them are adapted to the (transmission) spectra of the green and the red color filter.

The color filters which are customarily used in display devices have a comparatively large spectral bandwidth. This bandwidth, expressed in FWHM (=“full width at half maximum”) typically is of the order of ≧100 nm. This large bandwidth of these color filters can be attributed to the fact that, customarily, simple and inexpensive (color) absorption filters are used. In the known assembly, the light source used is a low-pressure mercury-vapor discharge lamp (fluorescent lamp) having a spectrum which, in operation, has a number of main bands at various wavelengths, while also a substantial part of the energy is emitted at different wavelengths. Since the fluorescent lamp emits a part of its energy in spectral ranges where the color filters are comparatively insensitive, the energy of the light source in the known assembly is converted comparatively inefficiently to a brightness of a picture to be displayed by the display device. As a result, the energy efficiency of the known assembly is comparatively low.

In the known assembly, a light source, which covers at least substantially the whole visible spectrum, is used in combination with color filters having a comparatively large bandwidth; as a result thereof, the color points that can be reached are all situated in a comparatively small (color) space of the 1931 C.I.E. color triangle known to those skilled in the art. If said (color) space is comparatively small, only a limited number of colors can be rendered by the display device. Furthermore, the so-called color saturation of such colors is comparatively low. Under these conditions, the colors of a picture displayed by the display device are perceived as being comparatively pale.

The inventors have recognized that by employing LEDs of different colors as the light source, said LEDs being associated with the color filters in the display device, the efficiency of the assembly is increased and the capacity to render colors of a picture displayed by the display device is improved. As the LEDs have a comparatively small bandwidth, the spectral emission of the LEDs can be adapted to the spectrum of the color filters such that an optimum energy conversion takes place in the assembly. By virtue of the combined action of the LEDs in the illumination system and the color filters in the display device, the energy efficiency of the assembly in accordance with the invention is increased.

An important further advantage of the use of LEDs as the light source over the to low-pressure mercury-vapor discharge lamps in the known assembly resides in that each one of the LEDs of a different color can be independently attuned to the color filter associated therewith, i.e. independent of the LEDs of a different color. This results in a great freedom of choice to optimally “associate” LEDs with various types of color filters. Dependent upon the color points, as laid down in international standards for pictures to be displayed by (picture) display devices, the most suitable mix of LEDs can be chosen. Examples of such international standards are the color triangles as laid down in standards such as NTSC, EBU, HDTV, etc., which are known to those skilled in the art.

In addition, as LEDs have a comparatively small bandwidth, larger color spaces in the C.I.E. color triangle can be encompassed. This leads to an increase of the number of colors that can be rendered by the display device. In addition, the colors rendered have a comparatively high color saturation. The measure in accordance with the invention enables a picture to be displayed on the display device having a great variety of bright and strong colors.

Combinations of said three or more LEDs of different colors enable color spaces to be formed in the 1931 C.I.E. color triangle, which are so large that the above-mentioned internationally standardized color triangles can be encompassed thereby. Control electronics in the assembly, for example driven by the display device, make sure that upon changing the emission standard, the light emitted by the LEDs is always optimally “attuned” to the selected internationally standardized color triangle. It is particularly suitable if the control electronics can be influenced by the user of the assembly, through a sensor which, for example, measures the color temperature of the ambient light, through a video card of, for example, a (personal) computer and/or through drive software of a computer program.

The use of LEDs having different light-emission wavelengths has the additional, further advantage that by controlling the relative intensities of the differently colored LEDs, the color point of a picture to be displayed by the display device can be adjusted without it being necessary to control the transmission factors of the pixels of the display device. In other words, the change of the color point of a picture displayed by the display device is controlled by the illumination system, not by the display device. By suitably unlinking the functions of the illumination system and the display device in the assembly, an increase of the contrast of the picture displayed by the display device is obtained. Since controlling the color point of the picture displayed by the display device is predominantly carried out by the illumination system, the transmission factors of the pixels of the display device can be optimally used to display a high-contrast picture. The use of LEDs yields dynamic illumination possibilities.

A preferred embodiment of the assembly in accordance with the invention is characterized in that

the light source comprises three light-emitting diodes having different light-emission wavelengths, and

the color filter comprises three color filters,

the spectral emission of each time one of the three light-emitting diodes being substantially adapted to the spectrum of one of the color filters.

In this preferred embodiment, the spectral characteristic of the LEDs of the first color is associated with the spectrum of the first color filter, the spectral characteristic of the LEDs of the second color is associated with the spectrum of the second color filter, and the spectral characteristic of the LEDs of the third color is associated with the spectrum of the third color filter. By using LEDs having different light-emission wavelengths, the spectral emission of each one of the LEDs of a different color can be optimally attuned to the spectrum of the color filter associated with the relevant LED. As a result, an optimum energy conversion is obtained in the assembly. By virtue of the combined action of the LEDs in the illumination system and the color filters in the display device, the energy efficiency of the assembly in accordance with the invention is increased.

A preferred embodiment is characterized in that

the light source comprises at least one blue light-emitting diode, at least one green light-emitting diode and at least one red light-emitting diode,

the color filter comprises a blue, a green and a red color filter, and

in operation, the blue color filter predominantly passes light originating from the blue light-emitting diode, the green color filter predominantly passes light originating from the green light-emitting diode and the red color filter predominantly passes light originating from the red light-emitting diode.

As a result of the great freedom regarding the choice of blue, green and red LEDs with a predetermined spectral maximum, a suitable LED can be found for each one of said blue, green and red color filters.

A preferred embodiment of the assembly in accordance with the invention is characterized in that at least one of the light-emitting diodes is chosen such that the wavelength associated with the spectral maximum of the light-emitting diodes corresponds to the wavelength associated with the spectral maximum of the corresponding color filter in the visible spectrum.

The color filters that are customarily used in display devices have a comparatively large spectral bandwidth. In general, the color filters have a so-called absorption band with a maximum. In general, the blue and the green color filter have a comparatively wide spectral transmission band in the visible spectrum. Given these spectral bands, it is comparatively easy to find a suitable LED enabling a good match of the maxima in the spectra of the LED and the color filter. Given these spectral bands, it is comparatively easy to find a suitable LED enabling the maxima in the spectra of the LED and the color filter to be properly matched. The red color filter has a wide band, which partly extends beyond the visible range and which has a wide maximum. As a result, the selection of a suitable red LED to match the red color filter also depends on other factors, for example the eye sensitivity curve. For this reason, use is often made of LEDs of four colors, namely a mix of blue, (bluish) green, amber and red LEDs, instead of the customary three basic colors.

As a large variety of LEDs is commercially available, it is comparatively simple to select the LED which, in terms of spectral emission, is adapted to the spectral maximum of the associated color filter. Preferably, the wavelength λ_{led}^{max} associated with the spectral maximum of at least one of the light-emitting diodes and the wavelength λ_{cf}^{max} associated with the spectral maximum of the corresponding color filter meet the relation:

$$\vert {λ}_{led}^{max} - {λ}_{cf}^{max} \vert \leq 5 nm .$$

It is favorable if the spectral bandwidth of the light-emitting diodes is comparatively small. In a preferred embodiment of the assembly, the spectral bandwidth (FWHM) of the light-emitting diodes lies in the range between 10≦FWHM≦50 nm.

Preferably, the spectral bandwidth lies in the range between 15≦FWHM≦30 nm. Many commercially available LEDs have a spectral bandwidth of approximately 20 nm.

The amount of light emitted by the LEDs is adjusted by varying the luminous flux of the light-emitting diodes. In general, this takes place in an energy-efficient way. For example, LEDs can be dimmed without an appreciable loss of light output. A preferred embodiment of the assembly in accordance with the invention is characterized in that the intensity of the light emitted by the light-emitting diodes varies in response to the illumination level of a picture to be displayed by the display device.

If, by way of example, the illumination level of a picture to be displayed by the display device is comparatively low, for example during playing a video film containing a scene which is shot under nightly conditions, the control electronics instructs the illumination system to reduce the light output of the LEDs accordingly. The illumination system couples out a comparatively small amount of light for illuminating the display device. The pixels of the display device do not have to be “pinched” to reduce the light from the illumination system. The transmission of the pixels of the display device can thus be optimally used to display a high-contrast picture. In this manner, a maximum-contrast picture can be obtained in spite of the comparatively low illumination level of the picture to be displayed.

When a picture with a comparatively low illumination level is displayed, in the known assembly, the transmission of the pixels is reduced to obtain the desired low illumination level. This leads to a low contrast of the picture, which is unfavorable and undesirable.

Low-pressure mercury-vapor discharge lamps used as the light source in an illumination system can be dimmed, however, this is a comparatively slow and energy-inefficient process.

By unlinking the illumination function and the display function of the display device, the illumination function being left to the illumination system, an assembly in accordance with the invention is obtained having dynamic contrast possibilities. The assembly in accordance with the invention yields, as it were, an intelligent backlight for illuminating the (picture) display device.

A particularly favorable embodiment of the assembly in accordance with the invention is characterized in that the intensity of the light emitted by the light-emitting diodes can be adjusted on a frame-to-frame basis. The luminous fluxes of the LEDs can be adjusted sufficiently rapidly to yield the desired light intensity on a frame-to-frame basis. LEDs can be dimmed without a noticeable loss of light output.

An alternative, favorable embodiment of the assembly in accordance with the invention is characterized in that the intensity of the light emitted by the light-emitting diodes can be adjusted for each color on a frame-to-frame basis. The luminous flux of each of the LEDs of a different color can be adjusted sufficiently rapidly to yield the desired light intensity on a frame-to-frame basis. An advantage of the adjustability of the LEDs on a color-to-color basis is that a (set of) video frame(s) can be provided with a “punch” or “boost” of a certain color. In this case, the light intensity of one type of the colored LEDs is temporarily set in the “overdrive” mode. The luminous flux through the other types of colored LEDs can be simultaneously reduced or even switched off, as desired.

Preferably, the light source comprises at least three light-emitting diodes having different light-emission wavelengths. A combination of red, green and blue LEDs, which is known per se, is very suitable. In an alternative embodiment, the light source comprises four LEDs having different light-emission wavelengths, i.e. a combination of red, green, blue and amber LEDs. Combinations of said three or more LEDs of different colors enable large spaces to be encompassed in the 1931 C.I.E. color triangle known to those skilled in the art.

Preferably, each of the light-emitting diodes has a luminous flux of at least 5 lm. LEDs having such a high output are alternatively referred to as LED power packages. The use of these high-efficiency, high-output LEDs has the specific advantage that the number of LEDs can be comparatively small at a desired, comparatively high light output. This adds to the compactness and efficiency of the illumination system to be manufactured. Further advantages of the use of LEDs are a comparatively very long service life, comparatively low energy costs and low maintenance costs of an illumination system comprising LEDs. The application of LEDs yields dynamic illumination possibilities.

These and other aspects of the invention will be apparent from and elucidated with reference to the embodiment(s) described hereinafter.

In the drawings:

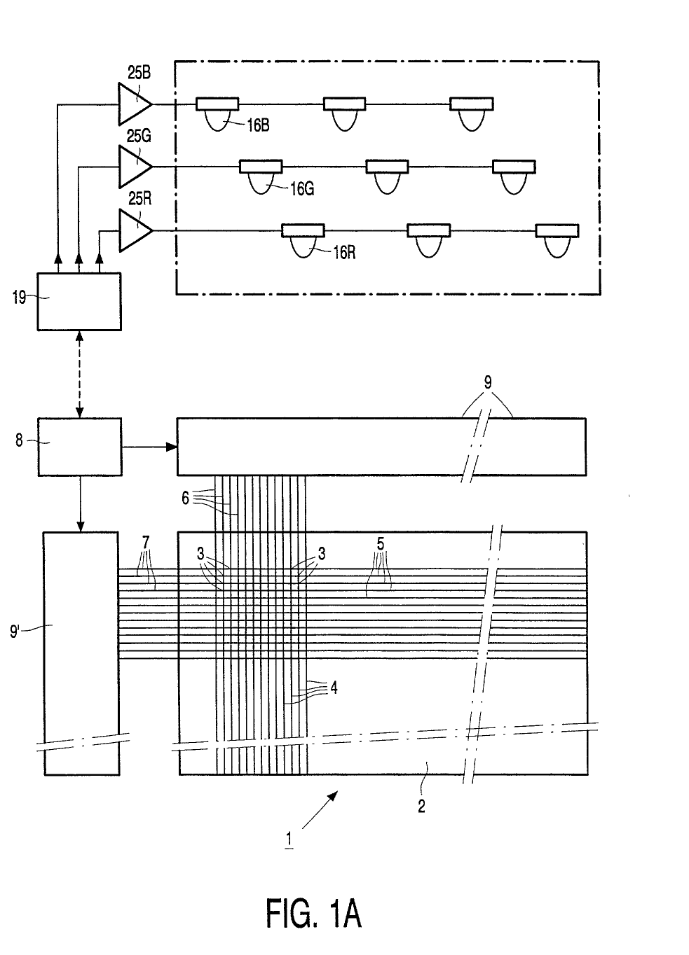

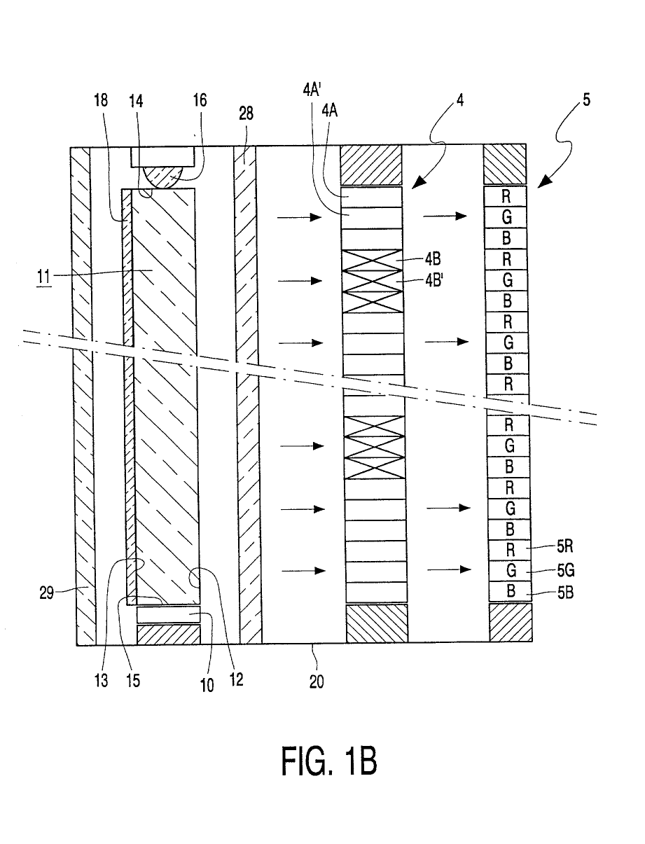

FIG. 1A diagrammatically shows a block diagram of an assembly comprising a display device and an illumination system;

FIG. 1B is a cross-sectional view of an embodiment of the assembly in accordance with the invention;

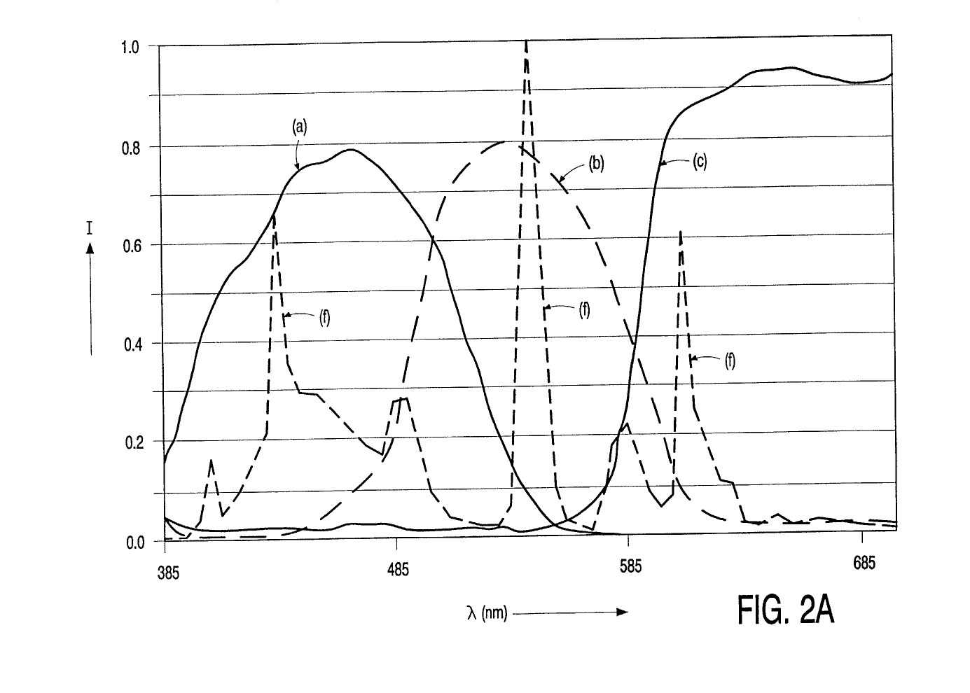

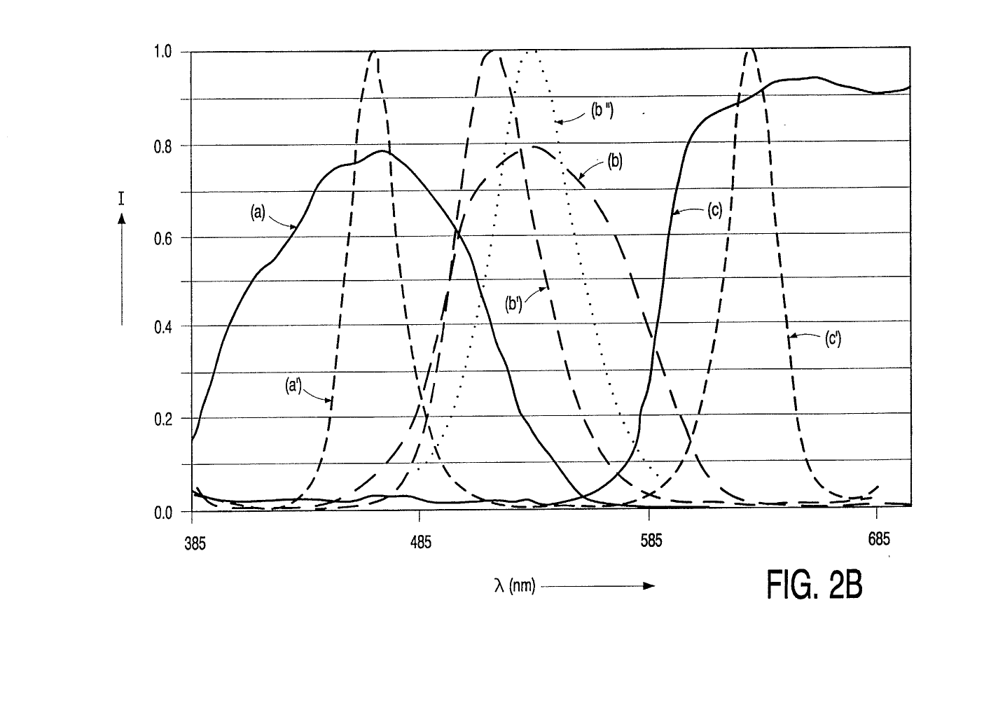

FIG. 2A shows a characteristic emission spectrum of a fluorescent lamp as used in the known assembly, and characteristic transmission spectra of a blue, green and red color filter as a function of the wavelength;

FIG. 2B shows a characteristic emission spectrum of blue, green and red LEDs and characteristic transmission spectra of a blue, green and red color filter as a function of the wavelength, and

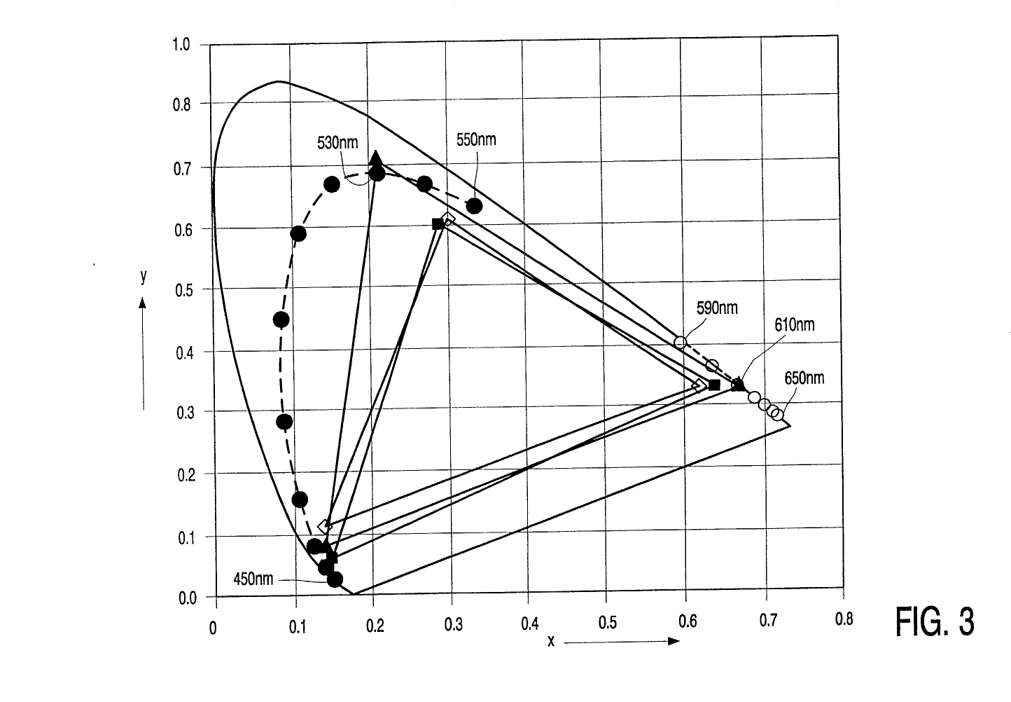

FIG. 3 shows a C.I.E. 1931 color triangle comprising a plurality of chromaticity co-ordinates for the LEDs in comparison with various color triangles in accordance with international standards for pictures to be displayed by (picture) display devices.

The Figures are purely diagrammatic and not drawn to scale. Particularly for clarity, some dimensions are exaggerated strongly. In the Figures, like-reference numerals refer to like-parts whenever possible.

FIG. 1 very diagrammatically shows a block diagram of an assembly comprising a display device and an illumination system. The (picture) display device comprises a substrate 1 having a surface 2 provided with a pattern of pixels 3, which are mutually separated (the distance between them being predetermined) in the vertical and the horizontal direction. Each pixel 3 is activated, during selection via a switching element, by means of an electrode 5 of a first group of electrodes, the voltage at a data electrode (electrode 4 of a second group of electrodes) determining the picture content. The electrodes 5 of the first group of electrodes are alternatively referred to as column electrodes, and the electrodes 4 of the second group of electrodes are alternatively referred to as row electrodes.

In a so-called actively driven display device, electrodes 4 receive (analog) control signals via parallel conductors 6 from a control circuit 9, and electrodes 5 receive (analog) control signals via parallel conductors 7 from a control circuit 9′. In an alternative embodiment of the display device, the electrodes are driven via a so-called passive drive.

To form a picture or a datagraphic representation in a relevant area of the surface 2 of the substrate 1 of the display device, the display device employs control electronics, in this example a control circuit 8, which drives the control circuits 9, 9′. In the display device, various types of electro-optical materials may be used. Examples of electro-optical materials are (twisted) nematic or ferroelectric liquid crystal materials. In general, the electro-optical materials attenuate the passed or reflected light in dependence upon a voltage applied across the material.

The illumination system which is very diagrammatically shown in FIG. 1A, comprises a plurality of light-emitting diodes (LEDs) 16B, 16G, 16R having different light-emission wavelengths which are driven, in the example shown in FIG. 1, via amplifiers 25B, 25G, 25R. Preferably, the LEDs are driven by the control electronics which are also used to drive the display device. This is diagrammatically indicated in FIG. 1A by means of the dotted line between the control circuit 8 of the display device and the control circuit 19 of the illumination system. This enables the intensity of the light emitted by the light-emitting diodes to be varied in response to the illumination level of a picture to be displayed by the display device. Preferably, the intensity of the light emitted by the light-emitting diodes can be adjusted on a frame-to-frame basis and for each color. The luminous flux of the LEDs can be adjusted sufficiently rapidly to yield the desired light intensity on a frame-to-frame basis. In addition, the luminous flux of each of the LEDs of a different color can be adjusted sufficiently rapidly to yield the desired illumination level and/or color mix on a frame-to-frame basis. In an alternative embodiment, the LEDs are driven by (external) control electronics.

In the example shown in FIG. 1A, reference numeral 16B denotes a plurality of blue LEDs, reference numeral 16G denotes a plurality of green LEDs, and reference numeral 16R denotes a plurality of red LEDs. Preferably, the LEDs are arranged in a (linear) row of alternately red, green and blue LEDs. In the example shown in FIG. 1A, the control circuit 19 drives the LEDs 16B, 16G, 16R on a color-to-color basis. In an alternative embodiment, the control electronics drives each one of the LEDs separately. An advantage of independently driving each one of the LEDs is that, for example in the case of failure of one of the LEDs, appropriate measures can be taken in the illumination system to compensate for the effect of this failure, for example by increasing the luminous flux of nearby LEDs of a corresponding color.

The source brightness of LEDs is many times that of fluorescent tubes. In addition, when use is made of LEDs, the efficiency with which light is coupled into the panel is higher than in the case of fluorescent tubes. The use of LEDs as the light source has the advantage that the LEDs may be in contact with panels made of a synthetic resin. LEDs hardly emit heat in the direction of the light-emitting panel 11, nor do they emit detrimental (UV) radiation. The use of LEDs has the additional advantage that means for coupling light originating from the LEDs into the panel are not necessary. The use of LEDs leads to a more compact illumination system.

The LEDs 16B, 16G, 16R used preferably are LEDs having a luminous flux above 5 lm. LEDs having such a high output are alternatively referred to as LED power packages. Examples of power LEDs are “Barracuda”-type LEDs (Lumileds). The luminous flux per LED is 15 lm for red LEDs, 13 lm for green LEDs, 5 lm for blue LEDs and 20 lm for amber LEDs. In an alternative embodiment, “Prometheus”-type LEDs (Lumileds) are used, the luminous flux per LED being 35 lm for red LEDs, 20 lm for green LEDs, 8 lm for blue LEDs and 40 lm for amber LEDs.

Preferably, the LEDs 16, 16′, 16″ are mounted on a (metal-core) printed circuit board. If power LEDs are provided on such a (metal-core) printed circuit board (PCB), the heat generated by the LEDs can be readily dissipated by means of heat conduction via the PCB. In an interesting embodiment of the illumination system, the (metal-core) printed circuit board is in contact with the housing of the display device via a heat-conducting connection.

FIG. 1B is a diagrammatic, cross-sectional view of an embodiment of the assembly in accordance with the invention. The illumination system comprises a light-emitting panel 11 of a light-transmitting material, which is made from, for example, a synthetic resin, acryl, polycarbonate, PMMA, such as Perspex, or glass. Under the influence of total internal reflection, light is transported, in operation, through the panel 11. The panel 11 has a front wall 12 and a rear wall 13 opposite said front wall. Between the front wall 12 and the rear wall 13, there are edge areas 14, 15. In the example shown in FIG. 1A, the edge area referenced 14 is light-transmitting, a light source 16 being associated with said edge area. This light source 16 comprises a plurality of LEDs of different colors 16B, 16G, 16R (see FIG. 1A; in FIG. 1B only one LED is shown).

In operation, light originating from the LEDs 16B, 16G, 16R is incident on the light-transmitting edge area 14 and diffuses in the panel 11. In accordance with the principle of total internal reflection, the light continues to move back and forth in the panel 11, unless the light is coupled out of the panel 11, for example, by a deformity, which is deliberately provided. The edge area opposite the light-transmitting edge area 14 bears reference numeral 15 and is, preferably, provided, except at the location where a sensor 10 is situated to measure the optical properties of the light emitted, in operation, by the LEDs, with a reflecting coating (not shown in FIG. 1B) for maintaining the light originating from the light source 16B, 16G, 16R within the panel. Said sensor 10 is coupled, for example, to the control circuit 19 (not shown in FIG. 1B) for suitably adapting and/or changing the luminous flux through the LEDs 16. By means of the sensor 10 and the control circuit 19, a feedback mechanism can be formed which is used to influence the quality and the quantity of the light coupled out of the panel 11.

Coupling means for coupling out light are provided on a surface 18 of the rear wall 13 of the light-emitting panel 11. These coupling means serve as a secondary light source. A specific optical system may be associated with this secondary light source, which optical system is provided, for example, on the front wall 12 (not shown in FIG. 2). The optical system may be used, for example, to form a broad light beam.

Said coupling means consist of (patterns of) deformities and comprise, for example, screen-printed dots, wedges and/or ridges. The coupling means are formed in the rear wall 13 of the panel 11, for example, by means of etching, scribing or sandblasting. In an alternative embodiment, the deformities are formed in the front wall 12 of the panel 11. The light is coupled out of the illumination system in the direction of the LCD display device (see the horizontal arrows in FIG. 1B) by means of reflection, scattering and/or refraction.

FIG. 1B shows an optional (polarizing) diffuser 28 and a (polarizing) reflective diffuser 29, which bring about further mixing of the light originating from the light-emitting panel 11, and which make sure that the light has the desired direction of polarization for the (LCD) (picture) display device.

FIG. 1B also very diagrammatically shows an example of an LCD display device comprising a liquid crystal display (LCD) panel 4 and a color filter 5. In the example shown in FIG. 1B, LC elements 4A, 4A′ are arranged so as to allow passage of light.

LC elements 4B, 4B′ (marked with a cross), however, do not pass light (see the horizontal arrows shown in FIG. 1B). In this example, the color filter 5 comprises three basic colors indicated by means of color filter 5B (blue), color filter 5G (green) and color filter 5R (red). The color filters 5B, 5G, 5R in the color filter 5 correspond to corresponding LC elements of the LCD panel 4. The color filters 5B, 5G, 5R only pass light which corresponds to the color of the relevant color filter.

The assembly of the illumination system comprising the light-emitting panel 11, the LEDs 16 and the display device comprising the LCD panel 4 and the color filter 5 in a housing 20, is used, in particular, to display (video) pictures or datagraphic information.

FIG. 2A shows a characteristic emission spectrum (curve f) of a fluorescent lamp as used in the known assembly, and characteristic transmission spectra of a blue (curve a), green (curve b) and red (curve c) color filter as a function of the wavelength λ in nm in the visible range. The emission spectrum of the fluorescent lamp, indicated by means of curve (f) in FIG. 2A, comprises a number of main bands at various wavelengths, while also a substantial part of the energy is emitted at other wavelengths. Since the fluorescent lamp emits a part of its energy in spectral regions where the color filters are comparatively insensitive, the energy of the light source is converted, in the known assembly, in a comparatively inefficient way into a brightness of a picture displayed by the display device. As a result, the energy efficiency of the known assembly is comparatively low. In addition, given the type of fluorescent lamp, the emission spectrum of the discharge lamp is fixed for the entire visible spectrum. It is not possible to shift bands in the spectrum with respect to each other in order to obtain a better match with the transmission spectra of the color filters. It is possible, however, to choose, as has been done in the known assembly, a discharge lamp comprising a different mixture of phosphors, for example a fluorescent lamp having a higher color temperature, the position of the various bands being moved with respect to the exemplary spectrum (curve f) in FIG. 2A.

The three color filters in the display device, indicated by means of curve (a), (b) and (c) in FIG. 2A, exhibit an absorption band with a maximum. In general, the blue color filter 5B (curve a) and the green color filter 5G (curve b) exhibit a comparatively wide spectral band in the visible spectrum. The red color filter 5R (curve c) has a wide band which is partly situated outside the visible range and, in addition, a comparatively wide maximum.

FIG. 2B shows characteristic emission spectra of blue (curve a′), green (curve b′) and red (curve c′) LEDs and characteristic transmission spectra of a blue (curve a), green (curve b) and red (curve c) color filter as a function of the wavelength λ in nm. The color filters (curve a, curve b and curve c) in FIG. 2B are the same as in FIG. 2A. Taking into consideration the shape of the transmission spectra of the blue color filter 5B (curve a) and the green color filter 5G (curve b), it is comparatively easy to find suitable LEDs for these spectral bands, enabling the maxima in the spectra of the LED and the color filter to be satisfactorily matched. The emission spectrum of the blue LED 16B (curve a′) has a maximum at approximately 465 nm and a FWHM of approximately 25 nm. The emission spectrum of the green LED 16G (curve b′) has a maximum at approximately 520 nm and a FWHM of approximately 40 nm.

An important advantage of the use of LEDs as a light source over the low-pressure mercury-vapor discharge lamp in the known assembly is that each of the differently colored LEDs can be attuned, independent of the LEDs of a different color, to the color filter associated therewith. For example, in FIG. 2B, the spectral match of the green LED (curve b′) in relation to the transmission spectrum (curve b) of the green color filter is not optimal. By choosing a green LED having an emission spectrum (curve b″) with a maximum at approximately 535 nm, the green LED is better adapted to the green color filter.

Since the red color filter 5R (curve c) has a wide band, which is partly situated outside the visible range, the choice of a suitable red LED 16R to match the red color filter 5R is also determined by other factors, for example the eye sensitivity curve. For this reason, use is often made of four colors of LEDs, namely a mix of blue, (bluish) green, amber and red LEDs, instead of the three basic colors (blue, green, red).

The use of LEDs having different light-emission wavelengths as a light source, said LEDs being associated with the color filters in the display device, results in an increased efficiency of the assembly and in an improved capacity for displaying colors of a picture displayed by the display device. Since the LEDs have a comparatively small bandwidth (FWHM, typically of the order of ≦50 nm), the spectral emission of the LEDs can be attuned to the spectrum of the color filters in such a manner that an optimum energy conversion takes place in the assembly. This results in a great freedom of choice to optimally “associate” LEDs with various types of color filters.

FIG. 3 shows a C.I.E. 1931 color triangle comprising a plurality of color co-ordinates for the LEDs, which color triangle is compared with various color triangles in accordance with international standards for pictures to be displayed by (picture) display devices. Two types of LEDs are shown, namely InGaN LEDs indicated by filled-in circles and AlInGaP LEDs indicated by open circles. FIG. 3 shows eleven InGaN LEDs of different colors, starting with an LED having a wavelength of maximum spectral emission at 450 nm, and the spectral emission of each of the following LEDs is 10 nm higher than that of the previous LED, the last LED having a wavelength of maximum spectral emission at 550 nm (several wavelengths of a number of LEDs are indicated in FIG. 3). In principle, LEDs can be manufactured at every intermediate wavelength (symbolized by the flowing broken line between the filled-in circles). FIG. 3 shows seven AlInGaP LEDs of different colors, starting with an LED having a wavelength of maximum spectral emission at 590 nm, and the spectral emission of each of the following LEDs is 10 nm higher than that of the previous LED, the last LED having a wavelength of maximum spectral emission at 650 nm (several wavelengths of a number of LEDs are indicated in FIG. 3). In principle, LEDs can be manufactured at every intermediate wavelength (symbolized by the broken line between the open circles).

FIG. 3 further shows various color triangles as laid down in international standards for pictures to be displayed by (picture) display devices. The vertices of the color triangle in accordance with the EBU standard are indicated by means of filled-in squares, and the vertices of the color triangle in accordance with the NTSC standard are indicated by means of filled-in triangles.

By using LEDs instead of fluorescent lamps as the light source, much larger color spaces in the C.I.E. color triangle can be encompassed. For example, the NTSC color space can be substantially covered by using blue LEDs having a wavelength of maximum spectral emission at 470 nm, green LEDs having a wavelength of maximum spectral emission at 530 nm, and red LEDs having a wavelength of maximum spectral emission at 610 nm. The EBU color space can be entirely covered by using blue LEDs having a wavelength of maximum spectral emission at 460 nm, green LEDs having a wavelength of maximum spectral emission at 545 nm and red LEDs having a wavelength of maximum spectral emission at 610 nm. By suitably choosing the mix of LEDs having different light emission wavelengths in the illumination system and by properly matching the LEDs and the color filters in the display device, an energy-efficient assembly is obtained, substantially all standard color spaces can be covered, and a display device is obtained which is capable of displaying pictures with a great variety of bright and strong colors.

The application, in the illumination system, of fluorescent lamps having a broadband emission spectrum in combination with broadband color filters in the display device leads to a limited color space in the C.I.E. 1931 color triangle. By way of example, FIG. 3 shows the vertices of the color space of a known active-matrix LCD, which are represented by open diamonds. This color space for an active-matrix LCD is comparatively limited in size, so that only a limited number of colors can be displayed by the display device.

In addition, in the known assembly, a white point is formed on the display device by guiding white light originating from fluorescent lamps with a fixed color temperature via the LC elements to the corresponding blue, green and red color filters. This is achieved by controlling the three LC elements in the transmission state. If a color temperature of the picture to be displayed by the display device is desired which differs from the color temperature corresponding to the light emitted by the fluorescent lamps, then the transmission factors of three LC elements are controlled such that the desired shift of the color temperature is obtained. As to that, it is generally necessary to block a substantial part of the light transmitted by the LC elements, because a change of the color temperature requires a substantial part of the blue or red light in the visible spectrum to be captured. Since the LC elements block a substantial part of the light, a considerable reduction in contrast of the image to be displayed occurs.

In the assembly in accordance with the invention, the change of the color temperature is unlinked from (the LC elements in) the display device and delegated to the illumination system. If a different color temperature of the picture to be displayed by the display device is desired, then the differently colored LEDs are driven in the illumination system (by the control circuit 19 of the illumination system in cooperation with the control circuit 8 of the display device) such that the color temperature of the light emitted by the illumination system is adapted to the desired color point of the picture to be displayed by the display device.

As a result thereof, the LC elements no longer have to contribute to the color temperature of the picture to be displayed by the display device, so that the LC elements can be used very effectively to display a high-contrast picture. The desired mixed colors of red, green and blue can thus be formed on the display device by guiding light originating from the illumination system via the LC elements to the corresponding blue, green and red color filters, the transmittance of each one of the LC elements corresponding to the desired color. In this situation, additional pinching of the LC elements is not necessary to simultaneously obtain the desired color temperature of the picture to be displayed by the display device.

It will be obvious that, within the scope of the invention, many variations are possible to those skilled in the art.

The scope of protection of the invention is not limited to the examples given hereinabove. The invention is embodied in each novel characteristic and each combination of characteristics. Reference numerals in the claims do not limit the scope of protection thereof. The use of the verb “to comprise” and its conjugations does not exclude the presence of elements other than those mentioned in the claims. The use of the article “a” or “an” in front of an element does not exclude the presence of a plurality of such elements.

1. An assembly comprising
a display device provided with a pattern of pixels (3) associated with color filters (5B, 5G, 5R), and
an illumination system for illuminating the display device,
said illumination system comprising a light-emitting panel (11) and at least one light source (16), said light source (16) being associated with the light-emitting panel (11), characterized in that
the light source (16) comprises at least three light-emitting diodes (16B, 16G, 16R) having different light-emission wavelengths,
said light-emitting diodes (16B, 16G, 16R) being associated with the color filters (5B, 5G, 5R).

2. An assembly as claimed in claim 1, characterized in that
the light source (16) comprises three light-emitting diodes (16B, 16G, 16R) having different light-emission wavelengths, and
the color filter comprises three color filters (5B, 5G, 5R),
the spectral emission of each time one of the three light-emitting diodes (16B; 16G; 16R) being substantially adapted to the spectrum of one of the color filters (5B; 5G; 5R).

3. An assembly as claimed in claim 1 or 2, characterized in that
the light source (16) comprises at least one blue light-emitting diode, at least one green light-emitting diode and at least one red light-emitting diode (16B, 16G, 16R),
the color filter (5B, 5G, 5R) comprises a blue, a green and a red color filter, and
in operation, the blue color filter (5B) predominantly passes light originating from the blue light-emitting diode (16B), the green color filter (5G) predominantly passes light originating from the green light-emitting diode (16G) and the red color filter (5R) predominantly passes light originating from the red light-emitting diode (16R).

4. An assembly as claimed in claim 1 or 2, characterized in that at least one of the light-emitting diodes (16B, 16G, 16R) is chosen such that the wavelength associated with the spectral maximum of the light-emitting diodes (16B, 16G, 16R) corresponds to the wavelength associated with the spectral maximum of the corresponding color filter (5B, 5G, 5R) in the visible spectrum.

5. An assembly as claimed in claim 4, characterized in that the wavelength λ_{led}^{max} associated with the spectral maximum of at least one of the light-emitting diodes (16B, 16G, 16R) and the wavelength λ_{cf}^{max} associated with the spectral maximum of the corresponding color filter (5B, 5G, 5R) meet the relation:
$$\vert {λ}_{led}^{max} - {λ}_{cf}^{max} \vert \leq 5 nm .$$

6. An assembly as claimed in claim 1 or 2, characterized in that the spectral bandwidth (FWHM) of the light-emitting diodes (16B, 16G, 16R) lies in the range between 10≦FWHM≦50 nm.

7. An assembly as claimed in claim 6, characterized in that the spectral bandwidth lies in the range between 15≦FWHM≦30 nm.

8. An assembly as claimed in claim 1 or 2, characterized in that the intensity of the light emitted by the light-emitting diodes (16B, 16G, 16R) varies in response to the illumination level of a picture to be displayed by the display device.

9. An assembly as claimed in claim 8, characterized in that the intensity of the light emitted by the light-emitting diodes (16B, 16G, 16R) can be adjusted on a frame-to-frame basis.

10. An assembly as claimed in claim 8, characterized in that the intensity of the light emitted by the light-emitting diodes (16B, 16G, 16R) can be adjusted for each color on a frame-to-frame basis.

11. An assembly as claimed in claim 1 or 2, characterized in that each one of the light-emitting diodes (16B, 16G, 16R) has a luminous flux of at least 5 lm.

12. An assembly as claimed in claim 11, characterized in that the light-emitting diodes (16B, 16G, 16R) are mounted on a printed circuit board.

13. A display device for use in an assembly as claimed in claim 1 or 2.

14. An illumination system for use in an assembly as claimed in claim 1 or 2.
